(19) United States
(12) Patent Application Publication
(10) Pub. No.: US 2006/0018275 A1
(43) Pub. Date: Jan. 26, 2006

(54) Apparatus and method for managing session information in a mobile communication service system

(75) Inventor: Sun-Yong Park, Gyeonggi-do (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/174,554

(22) Filed: Jul. 6, 2005

(30) Foreign Application Priority Data
Jul. 6, 2004 (KR) 2004-52410

(51) Int. Cl. H04Q 7/00

(52) U.S. Cl. 370/328

(57) ABSTRACT

An apparatus and method for managing session information in a mobile communication service system are provided. When a predetermined time has lapsed into a state where a point-to-point protocol (PPP) session established between a mobile station (MS) and a packet data serving node (PDSN) in the mobile communication service system was transitioned to a dormant state, the MS or PDSN is not transitioned to a null state, but still maintained in the dormant state when information on the established PPP session is checked if it is identical. Thereby, it is possible to maximize the efficiency of wired and wireless resources in the mobile communication service system, and to minimize a start time of mobile communication service provided by a request of the subscriber.

### CLAIM OF PRIORITY

This application claims the benefit under 35 U.S.C. §119(a) of an application entitled APPARATUS AND METHOD FOR MANAGING SESSION INFORMATION IN MOBILE COMMUNICATION SERVICE SYSTEM filed in the Korean Intellectual Property Office on 6 Jul., 2005 and assigned Serial No. 200-52410, the entire contents of which are incorporated herein by reference.

### BACKGROUND OF THE INVENTION

1. Field of the Invention

The present invention relates generally to an apparatus and method for managing session information in a mobile communication service system. More particularly, the present invention relates to an apparatus and method for managing session information in a mobile communication service system, in which, in a dormant state supported to provide fast service to a subscriber in a system where mobile communication service is provided, i.e., in an always-on mode where a Point-to-Point Protocol (PPP) session established between a mobile station and a Packet Data Serving Node (PDSN) is always maintained, information on the PPP session is efficiently managed, and a wireless resource of a wireless network and a wired resource of a wired network are efficiently used.

2. Description of the Related Art

Remote Wireless communication service technology establishes a packet network on an existing mobile communication network to provide wireless communication service to a mobile station (MS) that is in motion.

The packet network is composed of a packet data service node that sets up an environment to provide data service, and a packet transmission network that transmits a packet to the MS.

The packet transmission network is generally constructed of two systems: Universal Mobile Telecommunications System (UMTS) that has been standardized by Third Generation Partnership Project (3GPP), a European oriented standardization organization; and Code Division Multiple Access 2000 (CDMA 2000) that has been standardized by 3GPP2, a North American oriented standardization organization.

And, the packet transmission network based on the CDMA 2000 may be composed of a Packet Control Function (PCF), and a PDSN, and is connected to a base station (BS) that wirelessly exchanges CDMA signals with the MS.

The PCF manages a buffering function and a state of the MS until packets transmitted from the PDSN are wirelessly transmitted.

Further, the PDSN processes a Network Access Server (NAS) function to establish a Point-to-Point Protocol (PPP) session with the MS.

Specifically, the PDSN serves to establish, maintain and terminate the PPP session for the MS and a logic link to exchange data wirelessly, to convert data transmitted from the MS into packets, and to transmit the converted packets to an IP network.

According to a call processing procedure for providing the wireless communication service to the MS in the wireless communication service system, the PDSN establishes the PPP session with the MS when a service request message is received from the MS, wherein the PPP session is for providing service on the basis of a Link Control Protocol (LCP), an authentication procedure, and an Internet Protocol Control Protocol (IPCP).

The PDSN performs an access authentication procedure based on specific information of the MS, assigns an IP address to the MS, and registers the specific information of the MS.

Accordingly, the PDSN provides the wireless communication service through the PPP session which is established with the MS.

In the wireless communication service system, it is important to minimize a time to establish the PPP session for providing the wireless communication service to the MS.

Thus, in order to support the PPP session in an active state, a null state and a dormant state in the wireless communication service technology, various proposals have been suggested.

In the dormant state, a wireless link where the MS exchanges the packets is actually released, and the PPP session established with the PDSN is maintained. In this case, when there are packets to be exchanged while the PPP session established between the MS and the PDSN is maintained, the wireless link is established. Accordingly, a time to establish the wireless link for exchanging the packets is shortened.

Specifically, when no traffic is generated between the MS and the PDSN for a predetermined time, the dormant state is maintained for a predetermined time without conversion into the null state. Then, when the traffic is generated, a time to convert the state of the PPP session to the active state is minimized.

However, after the state of the PPP session between the MS and the PDSN is transitioned to the dormant state, the transitioned dormant state is transitioned to the null state after a predetermined time.

Therefore, in order to shorten the time to establish the PPP session between the MS and the PDSN to the highest degree, it is necessary to find a way where the MS or PDSN always maintains the PPP session in the dormant state.

### SUMMARY OF THE INVENTION

It is, therefore, an objective of the present invention to provide an apparatus and method for managing session information in a mobile communication service system, which can minimize the time to establish a Point-to-Point Protocol (PPP) session between a mobile station MS and a Packet Data Serving Node (PDSN) in the mobile communication service system when a traffic is generated, by efficiently managing information of the PPP session and always maintaining the PPP session in a dormant state.

According to an aspect of the present invention, there is provided a mobile communication service system comprising a packet data serving node (PDSN) for transmitting an acknowledgement request message comprising information on an established point-to-point protocol (PPP) session while the session is transitioned to a dormant state, and for managing PPP session state on the basis of the response message received from each terminal; a base station(BS) for transmitting through an overhead channel the acknowledgement request message received from the PDSN and transmitting the response message received through the overhead channel to the PDSN; and at least one terminal for comparing the session information included in the acknowledgement request message received from the BS with previously stored session information and transmitting the response message to the base station through the overhead channel.

According to another aspect of the present invention, there is provided a mobile communication service system comprising at least one terminal for transmitting an acknowledgement request message comprising information on an established session through an overhead channel while the session is transitioned to a dormant state; a packet data serving node (PDSN) for comparing the session information included in the acknowledgement request message with previously stored session information to generate and transmit a response message; and a base station for transmitting the response message received from each terminal to the PDSN and transmitting the acknowledgement request message provided from the PDSN to each terminal through the overhead channel.

According to still another aspect of the present invention, there is provided a method of managing session information in a mobile communication service system having at least one terminal, a base station and a packet data serving node (PDSN). The method comprising the steps of transmitting, by the PDSN, an acknowledgement request message comprising information on a session established with each of the terminals to base station while the session is transitioned to a dormant state; transmitting, by the base station, the acknowledgement request message to each of the terminals through an overhead channel; generating, by each of the terminals, a response message as a result of comparing the session information included in the acknowledgement request message received from the PDSN with previously stored session information, and transmitting the generated response message to the base station through an overhead channel; transmitting, by the base station, the response message to the PDSN; and managing, by the PDSN, a state of the session on the basis of the response message.

According to yet another aspect of the present invention, there is provided a method of managing session information in a mobile communication service system having at least one terminal, a base station and a packet data serving node (PDSN). The method comprising the steps of generating, by each of the terminals, an acknowledgement request message comprising information on a session established with the PDSN when the session is transitioned to a dormant state, and transmitting the generated acknowledgement request message to the base station through an overhead channel; transmitting, by the base station, the acknowledgement request message to the PDSN; generating, by the PDSN, a response message as a result of comparing the session information included in the acknowledgement request message with previously stored session information, and transmitting the generated response message to the base station; transmitting, by the base station, the response message to each of the terminals through the overhead channel; and managing, by each of the terminals, a state of the session on the basis of the response message.

According to yet another aspect of the present invention, a least one terminal in a mobile communication service system, the terminal comprising: Wireless interface for receiving acknowledgement request message from PDSN through overhead channel, and for transmitting response message through overhead channel; Response processor for generating response message as a result of comparing the PPP session information included in the acknowledgement request message with previously stored PPP session information, and for transmitting response message to PDSN though wireless interface.

According to yet another aspect of the present invention, a method of managing session information in a mobile communication service system having at least one terminal, the method comprising the steps of: Receiving, an acknowledgement request message comprising information on a PPP session though overhead channel; Generating, a response message as a result of comparing the PPP session information included in the acknowledgement request message received with previously stored session information; Transmitting, the response message though overhead channel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating an overall configuration for a network connection in a mobile communication service system;

FIG. 2 is block diagram illustrating an interface established in a mobile communication service system;

FIG. 3 is an internal block diagram of a mobile station (MS) according to a first embodiment of the present invention;

FIG. 4 is an internal block diagram of a packet data serving node (PDSN) according to a first embodiment of the present invention;

FIG. 5 is a flowchart showing the procedure of exchanging messages through a traffic channel according to a first embodiment of the present invention;

FIG. 6 is a flowchart showing the procedure of exchanging messages through an overhead channel according to a first embodiment of the present invention;

FIG. 7 is a flowchart illustrating a method of managing session information in a mobile communication service system according to a first embodiment of the present invention;

FIG. 8 is an internal block diagram of a PDSN according to a second embodiment of the present invention;

FIG. 9 is an internal block diagram of an MS according to a second embodiment of the present invention;

FIG. 10 is a flowchart showing the procedure of exchanging messages through a traffic channel according to a second embodiment of the present invention;

FIG. 11 is a flowchart showing the procedure of exchanging messages through a overhead channel according to a second embodiment of the present invention; and

FIG. 12 is a flowchart illustrating a method of managing session information in a mobile communication service system according to a second embodiment of the present invention.

### DETAILED DESCRIPTION OF EXEMPLARY EMBODIMENTS

Hereinafter, the present invention will be described in more detail with reference to the accompanying drawings, in which exemplary embodiments of the invention are shown. To enable a clear understanding of the present invention, related technology that is well known to those of ordinary skill in the technical field to which the present invention pertains, will not be described in detail.

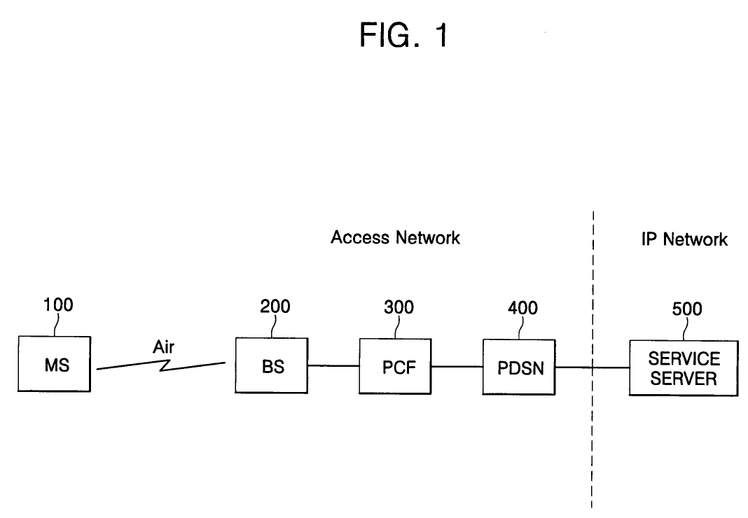

FIG. 1 is a block diagram illustrating an overall configuration for a network connection in a mobile communication service system.

Referring to FIG. 1, a mobile communication service system comprises a mobile station (MS) 100, a base station (BS) 200, a Packet Control Function (PCF) 300, and a Packet Data Serving Node (PDSN) 400, and a service server 500.

The MS 100 and the BS 200 is connected through a wireless link, and the BS 200, the PCF 300 and the PDSN are connected through a wired network.

And, the PDSN 400 is connected with the service server 500 through an Internet Protocol (IP) network.

The MS 100 transmits a Session Initiation Protocol (SIP) type request message to the BS 200 according to selection of a subscriber.

And, the BS 200 transmits the request message, which is received from the MS 100 within a service cell, to the PDSN 400 by way of the PCF 300.

The PDSN 400 establishes a Point-to-Point Protocol (PPP) session with the MS 100 on the basis of the received request message, converts the request message into an IP packet, and transmits the converted IP packet to the service server 500.

The service server 500 provides mobile communication service based on the request message that is received from the PDSN 400.

Here, the network comprising the BS 200, PCF 300 and PDSN 400 is called an access network which allows the MS 100 to access the IP network.

And, the service provided by the service server 500 may comprise real-time multimedia service, which is provided in interaction of the mobile communication network and the IP network, such as Push To Talk (PTT) service, Push To Data (PTD) service and Image Message (IM) service.

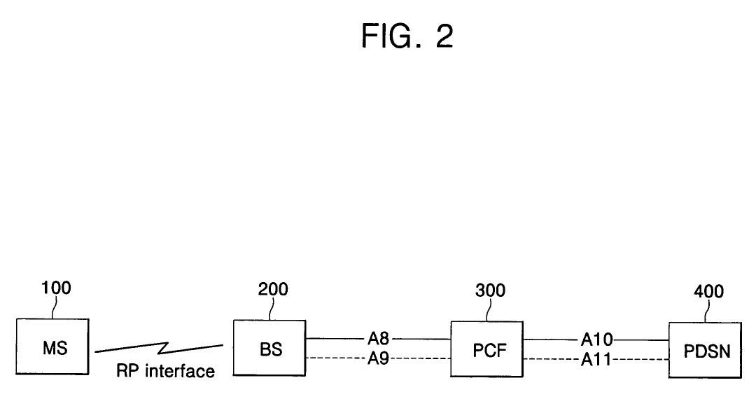

FIG. 2 is block diagram illustrating an interface established in a mobile communication service system.

As shown in FIG. 2, a Radio Packet (RP) interface is established between the MS 100 and the BS 200. A8/A9 interfaces are established between the BS 200 and the PCF 300. A10/A11 interfaces are established between the PCF 300 and the PDSN 400.

The A8 and A10 interfaces are for exchanging traffic, and the A9 and A11 interfaces are for signaling.

When the PPP session of the mobile communication service system is in an active state, this indicates that the A8 and A10 interfaces are established to exchange traffic. When the PPP session is in a dormant state, this indicates that the A10 interface is established, but the A8 interface is released.

In other words, in order to transition the dormant state of the PPP session to the active state, the A8 interface as the traffic interface should be established.

Further, the RP interface established between the MS 100 and the BS 200 may be divided into a traffic channel and an overhead channel.

The traffic channel may comprise a forward fundamental channel, a reverse fundamental channel, a forward dedication channel, a reverse dedication channel and so on.

The overhead channel may comprise a paging channel, an access channel, a forward common control channel, an enhanced access channel and so on.

And, the MS 100 or PDSN 400 may manage information on the PPP session in the mobile communication service system.

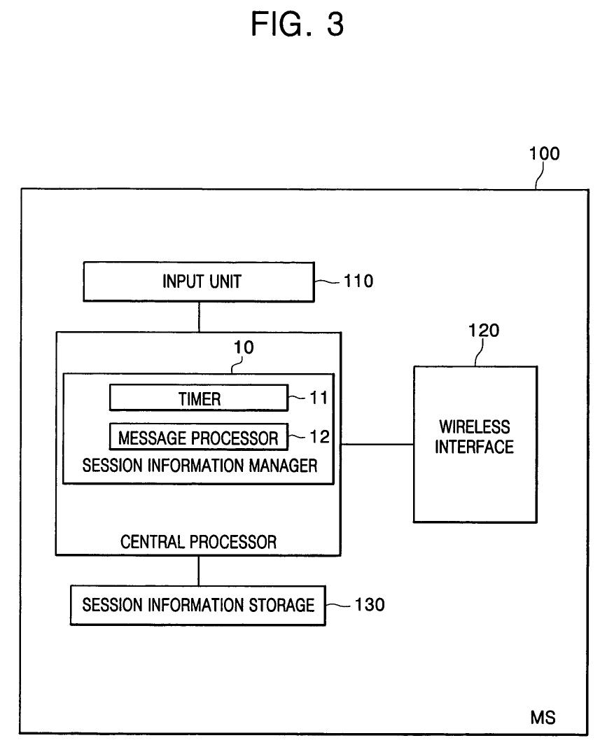

FIG. 3 is an internal block diagram of an MS according to a first embodiment of the present invention.

Referring to FIG. 3, an MS 100 of the present invention comprises a wireless interface 120, a central processor 140, an input unit 110 and a session information storage 130, wherein the central processor 140 comprises a session information manager 10.

The session information manager 10 comprises a timer 11 and a message processor 12.

The wireless interface 120 exchanges messages through a RP interface, i.e. a traffic or overhead channel, which is established with a BS 200 wirelessly.

And, the input unit 110 provides a key signal based on selection of a subscriber, and the central processor 140 generates a message based on the key signal received from the input unit 110 and then transmits the generated message to the BS 200.

Here, the central processor 140 transmits a service request message in a SIP format on the basis of the received key signal.

Further, the central processor 140 provides mobile communication service to the subscriber on the basis of data received through the BS 200.

The session information storage 130 stores information on a PPP session that is established with a PDSN 400 through the BS 200.

The PPP session information stored in the session information storage 130 may comprise Link Control Protocol (LCP) information, authentication information or Internet protocol control protocol (IPCP) information.

Here, LCP is a control protocol of a data link layer, which processes control functions such as PPP layer initiation of the data link layer. And, IPCP processes a function of automatically allocating an IP address prior to communication from among functions of PPP.

The session information manager 10 of the central processor 140 generates an acknowledgement request message at predetermined regular intervals or at irregular intervals, transmits the generated request message to the PDSN 400 through the BS 200, and manages the PPP session information stored in the session information storage 130 on the basis of a response message received from the PDSN 400.

And, the timer 11 of the session information manager 10 provides a due signal when a preset time has lapsed.

When the due signal is received from the timer 11, the message processor 12 generates the acknowledgement request message, transmits the generated request message to the PDSN 400, and manages the PPP session information stored in the session information storage 130 on the basis of the response signal received from the PDSN 400.

The acknowledgement request message generated by the message processor 12 may comprise any one of the LCP information, authentication information and IPCP information which are the PPP session information.

The acknowledgement request message generated by the message processor 12 can be transmitted through the traffic or overhead channel.

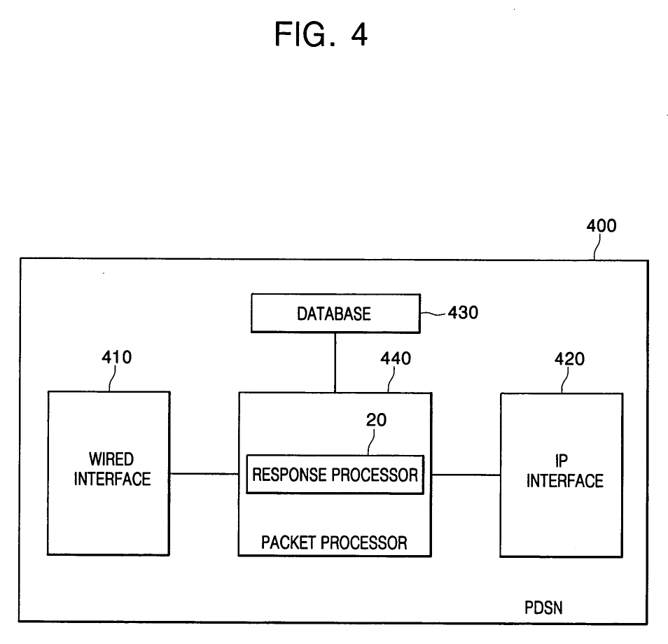

FIG. 4 is an internal block diagram of a PDSN according to a first embodiment of the present invention.

Referring to FIG. 4, a PDSN 400 of the present invention comprises a wired interface 410, a packet processor 440, a database 430 and an IP interface 420.

The wired interface 410 receives a message transmitted from a MS 100 by way of a BS 200.

And, the database 430 stores information on a PPP session established with the MS 100, and the IP interface 420 transmits an IP packet, which is received from the packet processor 440, to an IP network.

Here, the PPP session information stored in the database 430 is stored in the same manner as that stored in the MS 100 where the PPP session is established.

The packet processor 440 converts data received through the wired interface 410 into the IP packet, and transmits the converted IP packet to the IP network.

The packet processor 440 comprises a response processor 20. The response processor 20 compares the PPP session information included in an acknowledgement request message received from the MS 100 with that stored in the database 430. If they are equal to each other, the response processor 20 transmits an OK response message to the MS 100. In contrast, if not equal, the response processor 20 transmits a Not OK (NOK) response message to the MS 100. At this time, the response processor 20 encapsulates information on an overhead channel, which indicates that the message should be transmitted through the overhead channel, into a Generic Route Encapsulation (GRE) or IP header of the response message, and allows the response message to be transmitted through the overhead channel.

The MS 100 comprises a session information manager 10. When the OK response message is received from the PDSN 400, the session information manager 10 maintains the PPP session established with the PDSN 400. However, when the NOK response message is received, the session information manager 10 deletes the PPP session information stored in the session information storage 130, thereby terminating the PPP session or updating the PPP session information stored in the session information storage 130.

Specifically, when the OK response message is received from the PDSN 400, the session information manager 10 maintains the PPP session and a dormant state where the RP interface is released. However, when the NOK response message is received, the session information manager 10 is transitioned to a null state, or transmits a session information request message to the PDSN 400 to thereby update the PPP session information.

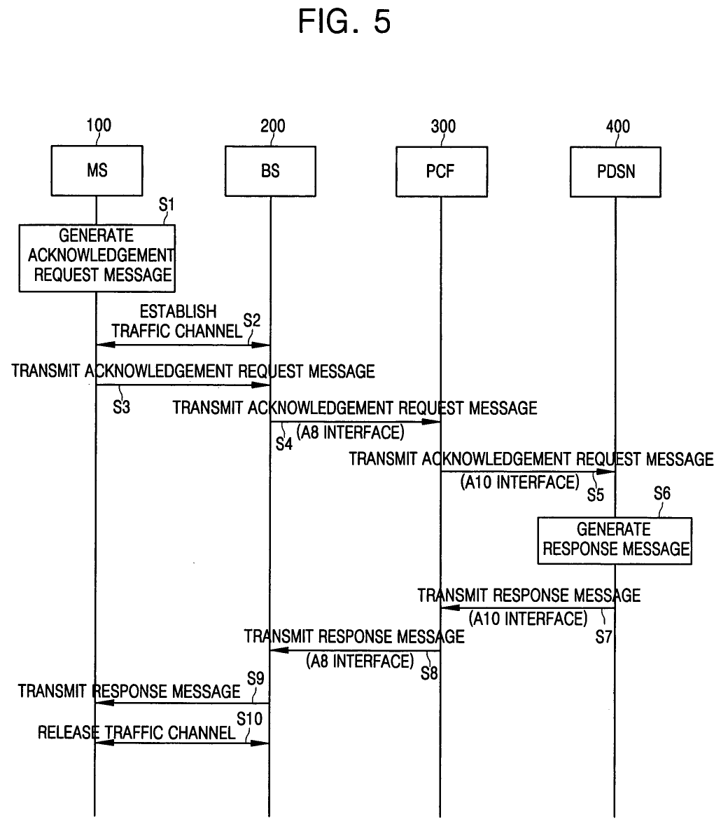

FIG. 5 is a flowchart showing the procedure of exchanging messages through a traffic channel according to a first embodiment of the present invention.

Referring to FIG. 5, after the PPP session established with the PDSN 400 was in a dormant state, namely after the RP interface was released and thereby only the PPP session was maintained, a predetermined time has lapsed. Then, the MS 100 generates an acknowledgement request message in which information of the PPP session is included, wherein the PPP session information is stored in the session information storage 130 at step S1.

In this case, the PPP session information may comprise LCP information, authentication information or IPCP information which is included in the acknowledgement request message. The following description will be made about an example where the LCP information is included in the acknowledgement request message. However, this description may be true of an example where any one of the others is included in the acknowledgement request message.

The MS 100 generates the acknowledgement request message in the dormant state at regular or irregular intervals.

The MS 100 and the BS 200 establish the RP interface for transmitting the acknowledgement request message at step S2.

To be specific, the MS 100 and the BS 200 are transitioned from the dormant state to an active state on the basis of a packet data termination call flow, and thus establish a traffic channel.

When the traffic channel is established between the MS 100 and the BS 200, the MS 100 transmits the generated acknowledgement request message to the BS 200 at step S3.

And, the BS 200 establishes an A8 interface in order to transmit the acknowledgement request message received from the MS 100, and transmits the acknowledgement request message to the PCF 300 through the A8 interface at step S4.

The PCF 300 transmits the received acknowledgement request message to the PDSN 400 through an A10 interface at step S5.

In other words, the BS 200 exchanges the acknowledgement request message transmitted to the PDSN 400 in a traffic form, thereby transmitting the acknowledgement request message through the A8/A10 interface for traffic exchange.

The PDSN 400 compares PPP session information included in the received acknowledgement request message with that stored in the database 430 to generate a response message at step S6.

At this time, the PDSN 400 generates an OK response message if LCP information included in the acknowledgement request message is identical to that stored in the database 430, and generate a NOK response message if not.

And, the PDSN 400 transmits the generated response message to the PCF 300 through the A10 interface at step S7, and the PCF 300 transmits the received response message to the BS 200 through the A8 interface at step S8.

The BS 200 transmits the received response message to the MS 100 through the traffic channel at step S9.

The MS 100 manages the PPP session information stored in the session information storage 130 on the basis of the received response message.

And, the MS 100 releases the traffic channel, which is the RP interface established with the BS 200 at step S10.

The MS 100 releases the RP interface established with the BS 200 and maintains the dormant state if the response message received from the PDSN 400 is the OK response message, and terminates the PPP session established with the PDSN 400 or transmits the session information request message to the PDSN 400 to update the current PPP session information with the PPP session information received because the MS 100 stores the PPP session information different from that of the PDSN 400 if the response message is the NOK response message.

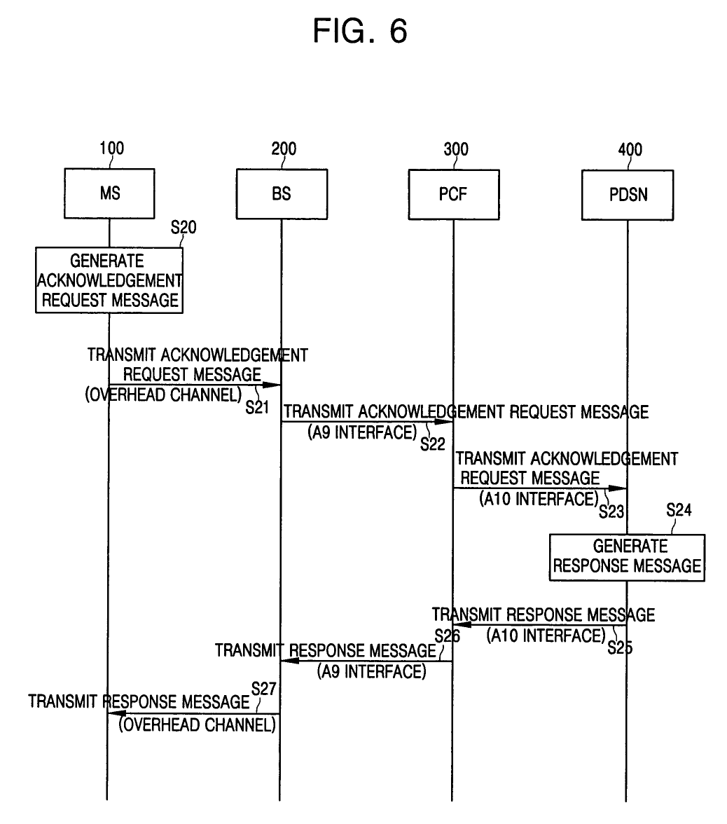

FIG. 6 is a flowchart showing the procedure of exchanging messages through a overhead channel according to a first embodiment of the present invention.

Referring to FIG. 6, when a predetermined time has lapsed at regular or irregular intervals in a dormant state where a PPP session is established between the MS 100 and the PDSN 400, the MS 100 generates an acknowledgement request message in which PPP session information stored in the session information storage 130 is included at step S20.

The MS 100 transmits the acknowledgement request message to the BS 200 through an overhead channel at step S21.

And, the BS 200 transmits the acknowledgement request message received from the MS 100 to the PCF 300 through an A9 interface at step S22.

The PCF 300 transmits the received acknowledgement request message to the PDSN 400 through an A10 interface maintained in the dormant state at step S23.

The PDSN 400 compares the PPP session information included in the received acknowledgement request message with that stored in the database 430, and generates a response message at step S24.

Here, the PDSN 400 generates an OK response message if LCP information included in the acknowledgement request message is identical to that stored in the database 430, and generates a NOK response message and encapsulates information on the overhead channel into a GRE or IP header if not.

And, the PDSN 400 transmits the generated response message to the PCF 300 through the A10 interface at step S25, and the PCF 300 transmits the response message to the BS 200 through the A8 interface at step S26.

The BS 200 transmits the received response message to the MS through the overhead channel at step S27.

The MS 100 manages the PPP session information according to a type of the received response message.

The MS 100 releases the RP interface established with the BS 200 and maintains the dormant state if the response message received from the PDSN 400 is the OK response message, and terminates the PPP session established with the PDSN 400 or transmits the session information request message to the PDSN 400 to update the current PPP session information with the received PPP session information because the MS 100 stores the PPP session information different from that of the PDSN 400 if the response message is the NOK response message.

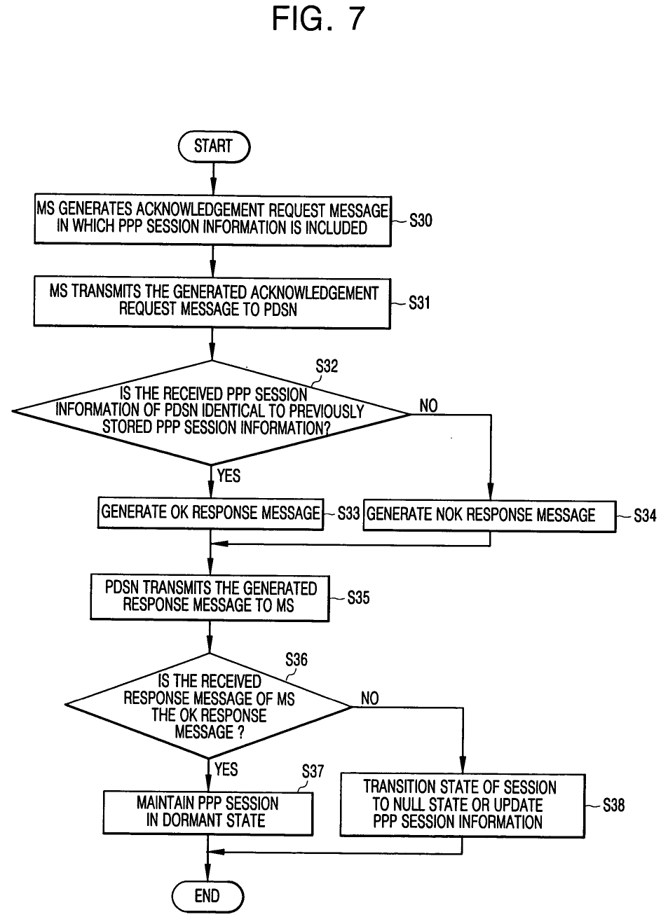

FIG. 7 is a flowchart illustrating a method of managing session information in a mobile communication service system according to a first embodiment of the present invention.

Referring to FIG. 7, a PPP session established between the MS 100 and the PDSN 400 is transitioned to a dormant state, the MS 100 counts whether the dormant state is maintained for a predetermined time. When a preset predetermined time has lapsed, the MS 100 generates an acknowledgement request message in which PPP session information stored in the session information storage 130 is included at step S30.

Then, the MS 100 transmits the generated acknowledgement request message to the PDSN 400 by way of the BS 200 at step S31.

Here, the MS 100 can transmit the acknowledgement request message through a traffic or overhead channel. When the acknowledgement request message is transmitted through the traffic channel, the MS 100 preferably transmits the acknowledgement request message after establishing the traffic channel with the BS 200.

The BS 200 establishes an A8 interface to transmit the acknowledgement request message to the PCF 300 when the received acknowledgement request message is transmitted through the traffic channel in a data format.

The PDSN 400 compares the PPP session information included in the acknowledgement request message received from the MS 100 with that stored in the database 430 at step S32. If they are identical to each other, the PDSN 400 generates an OK response message at step S33. In contrast, if not, the PDSN 400 generates a NOK response message and encapsulates information on an overhead channel into a GRE or IP header of the response message at step S34.

Then, the PDSN 400 transmits the generated response message to the MS 100 through the overhead channel by way of the PCF 300 and BS 200 at step S35.

The MS 100 checks whether the received response message is the OK response message or the NOK response message at step S36. If the received response message is the OK response message, the MS 100 maintains the PPP session established with the PDSN 400 in the dormant state at step S37. However, if the received response message is the NOK response message, the MS 100 transitions a state of the PPP session into a null state, or transmits a session information request message to the PDSN 400 to update the current session information with session information received at step S38.

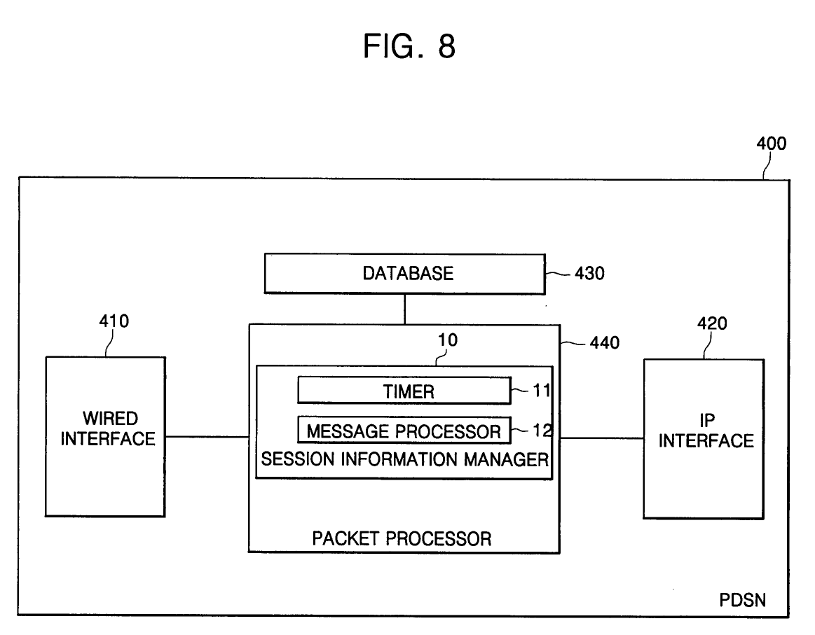

FIG. 8 is an internal block diagram of a PDSN according to a second embodiment of the present invention.

An example where information on a PPP session established between an MS 100 and a PDSN 400 is managed by the PDSN 400 will be described with reference to FIG. 8.

As shown in FIG. 8, a PDSN 400 comprises a packet processor 440 which has a session information manager 10. The session information manager 10 comprises a timer 11 for providing a due signal after the lapse of a preset predetermined time, and a message processor 12 for generating an acknowledgement request message in which PPP session information stored in a database 430 and channel information indicating that a message should be transmitted in a signaling traffic are included when the due signal is received from the timer 11.

In order words, the PDSN 400 encapsulates and transmits the overhead channel information into a GRE or IP header of the acknowledgement request message in which the PPP session information is included, and the overhead channel information may be allocated to a reserved field of the GRE or IP header.

Further, the PDSN 400 can generate the acknowledgement request message by causing the PPP session information and the overhead channel information to be included in a message such as an LCP echo request message.

And, the session information manager 10 transmits the generated acknowledgement request message to an MS 100 through the traffic or overhead channel, and manages the PPP session information stored in the database 430 on the basis of a response message received from the MS 100.

In other words, the PDSN 400 shown in FIG. 8 manages the PPP session information when the PPP session established with the MS 100 is transitioned to a dormant state.

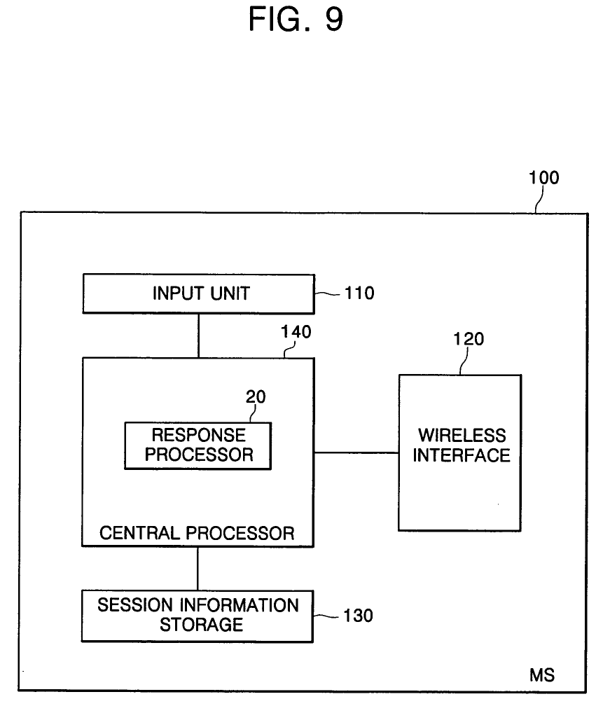

FIG. 9 is an internal block diagram of a MS according to a second embodiment of the present invention.

Referring to FIG. 9, a MS 100 comprises a central processor 140 which has a response processor 20. The response processor 20 compares PPP session information included in an acknowledgement request message received through a wireless interface 120 with that stored in a session information storage 130, and transmits a response message through a traffic or overhead channel.

Thus, if the PPP session information included in the acknowledgement request message received from a PDSN 400 is identical to that stored in the session information storage 130, the MS 100 transmits an OK response message. However, if not, the MS 100 transmits a NOK response message.

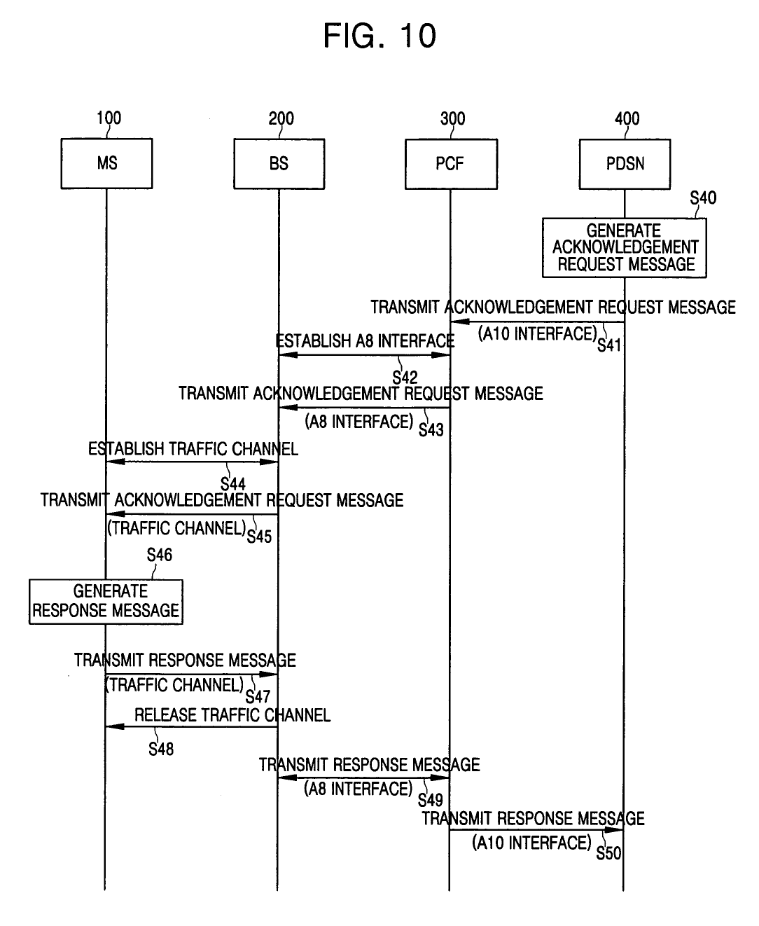

FIG. 10 is a flowchart showing the procedure of exchanging messages through a traffic channel according to a second embodiment of the present invention.

Referring to FIG. 10, when a PPP session established between the MS 100 and the PDSN 400 is in a dormant state, the timer 11 provides a due signal after the lapse of a predetermined time, and the message processor 12 generates an acknowledgement request message in which PPP session information stored in the database 430 is included at step S40.

Here, the message processor 12 generates the acknowledgement request message in which the PPP session information is included after a predetermined time has lapsed at regular or irregular intervals.

And, the PDSN 400 transmits the generated acknowledgement request message to the PCF 300 through an A10 interface in a data format at step S41.

When the acknowledgement request message is received from the PDSN 400, the PCF 300 establishes an A8 interface according to a packet data termination call flow, and transitions a dormant state of the PPP session to an active state at step S42.

And, the PCF 300 transmits the acknowledgement request message to the BS 200 through the A8 interface at step S43.

When the acknowledgement request message is received from the PCF 300 through the A8 interface as the traffic channel, the BS 200 establishes the traffic channel with the MS 100 at step S44, and transmits the acknowledgement request message to the MS 100 at step S45.

And, the MS 100 generates an OK response message if the PPP session information included in the received acknowledgement request message is identical to that stored in the session information storage 130, and generates a NOK response message if not at step S46.

The MS 100 transmits the generated response message to the BS 200 through the established traffic channel at step S47, and then releases the traffic channel at step S48.

Here, the MS 100 transmits the response message to release the traffic channel, or waits for reception of a session information request message from the PDSN for a predetermined time. When the session information request message is received, the MS 100 transmits the PPP session information stored in the session information storage 130 to the PDSN 400 or releases the traffic channel after the lapse of a predetermined time.

The BS 200 transmits the received response message to the PCF 300 through an A8 interface at step S49, and then the PCF 300 transmits the response message to the PDSN 400 through an A10 interface at step S50.

The PCF 300 transmits the response message to the PDSN 400, and then releases the established A8 interface.

The PDSN 400 manages the PPP session information stored in the database 430 on the basis of the received response message.

Specifically, the PDSN 400 maintains the PPP session established with the MS 100 in the dormant state if the received response message is the OK response message. However, if the response message is the NOK response message, the PDSN 400 terminates the PPP session established with the MS 100, or transmits the session information request message to the MS 100 to update the current PPP session information with the received PPP session information because the PDSN 400 stores the PPP session information different from that of the MS 100.

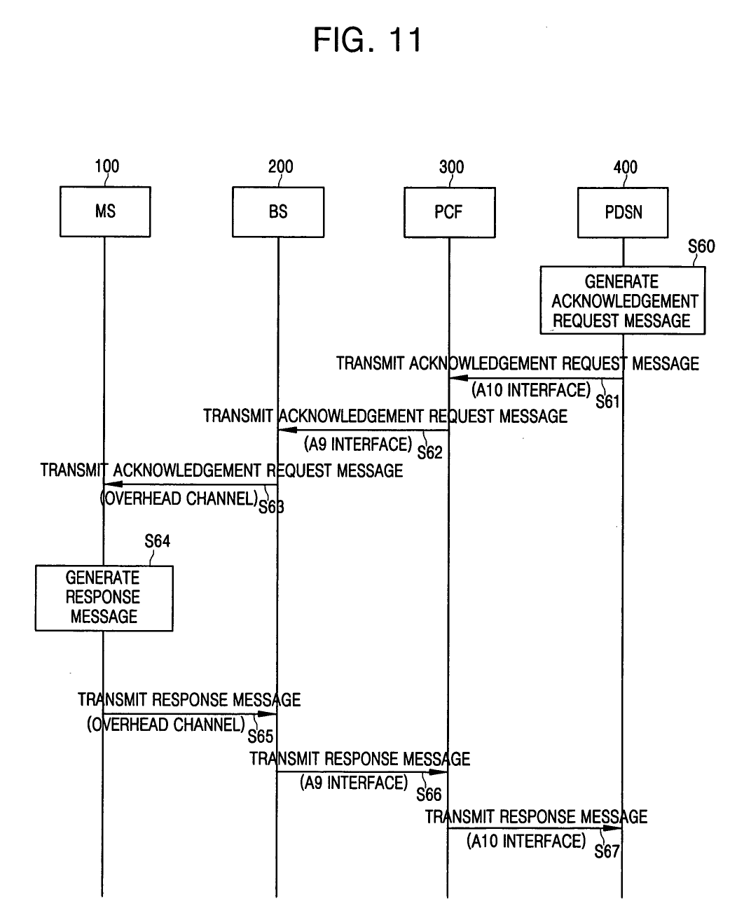

FIG. 11 is a flowchart showing the procedure of exchanging messages through a overhead channel according to a second embodiment of the present invention.

Referring to FIG. 11, when a PPP session established between the MS 100 and the PDSN 400 is in a dormant state, the timer 11 provides a due signal after the lapse of a predetermined time, and the message processor 12 generates an acknowledgement request message in which PPP session information and overhead channel information stored in the session information storage 130 are included at step S60.

And, the PDSN 400 transmits the generated acknowledgement request message to the PCF 300 through an A10 interface in a data format at step S61.

The PCF 300 transmits the received acknowledgement request message to the BS 200 through an A9 interface at step S62.

At this time, the PDSN 400 comprises the overhead channel information in the acknowledgement request message such that the PCF 300 or BS 200 transmits the received acknowledgement request message of a data format to the MS 100 through the overhead channel, and the BS 200 transmits the acknowledgement request message in a mode of Short Data Burst (SDB) when the overhead channel information is included in the received acknowledgement request message.

Further, the PDSN 400 encapsulates the overhead channel information into a GRE or IP header of the acknowledgement request message such that the PCF 300 or BS 200 can transmit the acknowledgement request message to the MS 100 in the SDB mode, and the PCF 300 or BS 200 transmits the acknowledgement request message to the MS 100 through the overhead channel according to the SDB mode when the overhead channel information is encapsulated into the GRE or IP header of the acknowledgement request message.

The BS 200 transmits the acknowledgement request message, which is received from the PCF 300, to the MS 100 through the overhead channel at step S63.

At this time, the BS 200 recognizes, from the GRE or IP header of the received data, the acknowledgement request message as a message to be transmitted through the overhead channel, and then transmits a Data Burst Message (DBM) to the MS 100, wherein the received acknowledgement request message is included in the DBM.

And, the MS 100 compares PPP session information included in the received acknowledgement request message with that stored in the session information storage 130. If they are identical to each other, the MS 100 generates an OK response message. However, if not, the MS 100 generates a NOK response message at step S64.

The MS 100 transmits the generated response message to the BS 200 through the overhead channel at step S65, and the BS 200 transmits the received response message to the PCF 300 through the A9 interface at step S66.

At this time, the MS 100 transmits the DBM in which the response message is included to the BS 200 through the overhead channel.

The PCF 300 transmits the response message, which is received from the BS 200, to the PDSN 400 through the A10 interface at step S67, and the PDSN 400 manages the PPP session information stored in the database 430 on the basis of the received response message.

Specifically, the PDSN 400 maintains the PPP session established with the MS 100 in the dormant state if the response message received from the MS 100 is the OK response message. However, if the response message is the NOK response message, the PDSN 400 terminates the PPP session established with the MS 100, or transmits the session information request message to the MS 100 to update the current PPP session information with the received PPP session information because the PDSN 400 stores the PPP session information different from that of the MS 100.

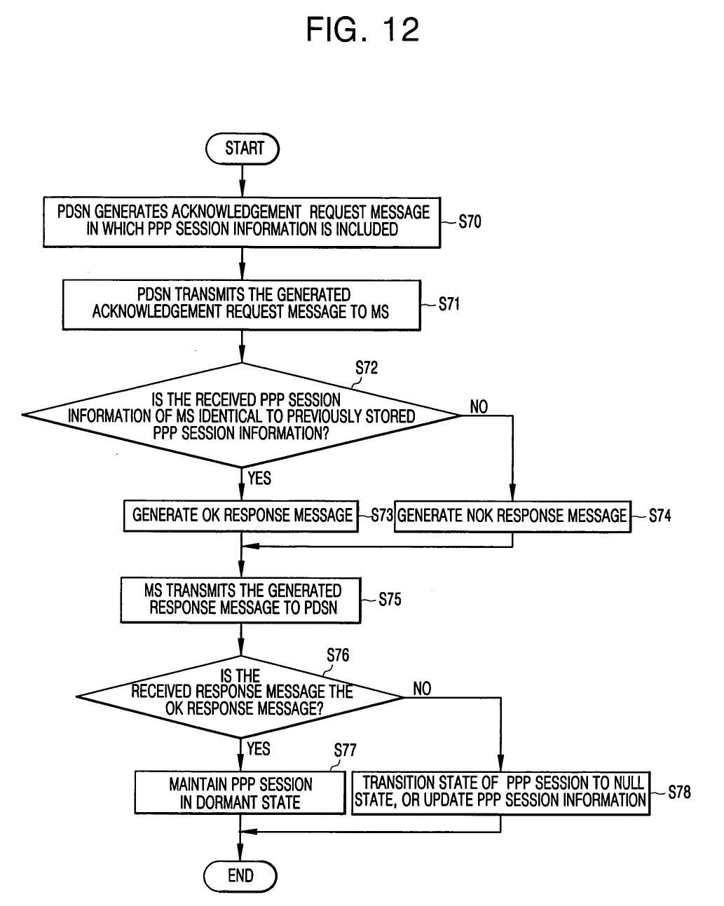

FIG. 12 is a flowchart illustrating a method of managing session information in a mobile communication service system according to a second embodiment of the present invention.

Referring to FIG. 12, when a preset predetermined time has lapsed after a PPP session established with the MS 100 was transitioned to a dormant state, the PDSN 400 generates an acknowledgement request message in which PPP session information and overhead channel information stored in the database 430 are included at step S70.

And, the PDSN 400 transmits the generated acknowledgement request message to the MS 100 at step S71.

At this time, the PDSN 400 may transmit the acknowledgement request message to the MS 100 through a traffic or overhead channel. When the acknowledgement request message is transmitted to the MS 100 through the traffic channel, the PCF 300 establishes an A8 interface for transmitting the acknowledgement request message received from the PDSN 400, and the BS 200 establishes the traffic channel with the MS 100.

And, the PCF 300 transmits the acknowledgement request message through the established A8 interface, and then the BS 200 transmits the acknowledgement request message, which is received from the PCF 300, to the MS 100.

Further, the PDSN 400 transmits the generated acknowledgement request message to the PCF 300 in a data format.

In contrast, when transmitting the acknowledgement request message through the overhead channel, the PDSN 400 encapsulates the overhead channel information into a GRE or IP header of the acknowledgement request message, and then transmits the acknowledgement request message to the PCF 300 through the A10 interface in the data format.

And, when the overhead channel information is encapsulated into the GRE or IP header of the received acknowledgement request message, the PCF 300 or BS 200 transmits the acknowledgement request message to the MS 100 through the overhead channel.

The MS 100 compares the PPP session information included in the acknowledgement request message received from the PDSN 400 with that stored in the session information storage 130 at step S72. If they are identical to each other, the MS 100 generates an OK response message at step S73. However, if not, the MS 100 generates a NOK response message at step S74.

Then, the MS 100 transmits the generated response message to the BS 200 through the overhead channel, and then the BS 200 transmits the received response message to the PDSN 400 by way of the PCF 300 at step S75.

The PDSN 400 checks whether or not the received response message is the OK response message at step S76. If the response message is the OK response message, the PDSN 400 maintains the PPP session established with the MS 100 in the dormant state at step S77. If the response message is the NOK response message, the PDSN 400 transitions a state of the PPP session into a null state, or transmits the session information request message to the MS 100 to update the current PPP session information with the received PPP session information at step S78.

As set forth above, according to the embodiments of the present invention, when a predetermined time has lapsed in the state where the PPP session established between the MS and the PDSN in the mobile communication service system was transitioned to the dormant state, the PPP session is not transitioned to the null state, but it is still maintained in the dormant state when information on the established PPP session is checked to be identical, and thereby it is possible to maximize a time when the PPP session established between the MS and the PDSN is maintained in the dormant state.

Therefore, it is possible to maximize the efficiency of wired and wireless resources in the mobile communication service system, and to minimize a start time of mobile communication service provided by request of the subscriber.

Although exemplary embodiments of the present invention have been described, it will be understood by those skilled in the art that the present invention should not be limited to the described exemplary embodiments. Various changes and modifications can be made within the spirit and scope of the present invention as defined by the following claims.

What is claimed is:

1. A mobile communication service system comprising:
a packet data serving node (PDSN) for transmitting an acknowledgement request message comprising information on an established point-to-point protocol (PPP) session while the session is transitioned to a dormant state, and for managing PPP session state on the basis of the response message received from each terminal;
a base station(BS) for transmitting through an overhead channel the acknowledgement request message received from the PDSN and transmitting the response message received through the overhead channel to the PDSN; and
at least one terminal for comparing the session information included in the acknowledgement request message received from the BS with previously stored session information and transmitting the response message to the base station through the overhead channel.

2. The mobile communication service system of claim 1, wherein the PDSN comprises:
a message processor for generating the acknowledgement request message comprising the PPP session information at predetermined regular or irregular intervals while the PPP session established with each terminal is transitioned to the dormant state, and receiving the response message from each terminal; and
a session manager for managing a state of the session on the basis of the response message received from the massage processor.

3. The mobile communication service system of claim 2, wherein the message processor encapsulates information on the overhead channel into a predetermined field of a generic route encapsulation (GRE) header of the acknowledgement request message.

4. The mobile communication service system of claim 2, wherein the message processor encapsulates information on the overhead channel into a predetermined field of an to Internet protocol (IP) header of the acknowledgement request message.

5. The mobile communication service system of claim 1, wherein the base station transmits the acknowledgement request message to each terminal through the overhead channel when signaling information is included in a GRE header of the acknowledgement request message.

6. The mobile communication service system of claim 1, wherein the base station transmits the acknowledgement request message to each terminal through the overhead channel when signaling information is included in an IP header of the acknowledgement request message.

7. The mobile communication service system of claim 1, wherein the overhead channel comprises one of a paging channel, an access channel, a forward common control channel, and an enhanced access channel.

8. The mobile communication service system of claim 1, wherein the PDSN generates the acknowledgement request message by comprising information on the PPP session and information on the overhead channel in a link control protocol (LCP) echo request message.

9. The mobile communication service system of claim 1, wherein the PDSN performs one of an operation of maintaining the session state in the dormant state, an operation of transitioning the PPP session to a null state, and an operation of updating the session information on the basis of the response message received from each terminal.

10. A mobile communication service system comprising:
at least one terminal for transmitting an acknowledgement request message comprising information on an established session through an overhead channel while the session is transitioned to a dormant state;
a packet data serving node (PDSN) for comparing the session information included in the acknowledgement request message with previously stored session information to generate and transmit a response message; and
a base station for transmitting the response message received from each terminal to the PDSN and transmitting the acknowledgement request message provided from the PDSN to each terminal through the overhead channel.

11. The mobile communication service system of claim 10, wherein each terminal comprises:
a message processor for generating the acknowledgement request message comprising the session information at predetermined regular or irregular intervals while the session established with the PDSN is transitioned to the dormant state, and receiving the response message from the PDSN; and
a session manager for managing a state of the session on the basis of the response message received from the massage processor.

12. The mobile communication service system of claim 10, wherein the PDSN encapsulates information on the overhead channel into a predetermined field of a generic route encapsulation (GRE) header of the response message.

13. The mobile communication service system of claim 10, wherein the message processor encapsulates information on the overhead channel into a predetermined field of an Internet protocol (IP) header of the response message.

14. The mobile communication service system of claim 10, wherein the base station transmits the response message to each of the terminals through the overhead channel when signaling information is included in a GRE header of the response message.

15. The mobile communication service system of claim 10, wherein the base station transmits the response message to each of the terminals through the overhead channel when signaling information is included in an IP header of the response message.

16. A method of managing session information in a mobile communication service system having at least one terminal, a base station and a packet data serving node (PDSN), the method comprising the steps of:
transmitting, by the PDSN, an acknowledgement request message comprising information on a session established with each of the terminals to the station while the session is transitioned to a dormant state;
transmitting, by the base station, the acknowledgement request message to each of the terminals through an overhead channel;
generating, by each of the terminals, a response message as a result of comparing the session information included in the acknowledgement request message received from the PDSN with previously stored session information, and transmitting the generated response message to the base station through an overhead channel;
transmitting, by the base station, the response message to the PDSN; and
managing, by the PDSN, a state of the session on the basis of the response message.

17. The method of claim 16, wherein the step of generating the acknowledgement request message comprises a step of generating the acknowledgement request message comprising information on the session and information on overhead channel at predetermined regular or irregular intervals while the session is transitioned to the dormant state.

18. The method of claim 16, wherein the step of generating the acknowledgement request message comprises a step of generating the acknowledgement request message by encapsulating information on the overhead channel into a predetermined field of a generic route encapsulation (GRE) header.

19. The method of claim 16, wherein the step of generating the acknowledgement request message comprises a step of generating the acknowledgement request message by encapsulating information on the overhead channel into a predetermined field of an Internet protocol (IP) header.

20. The method of claim 16, wherein, in the step of transmitting the acknowledgement request message, the base station transmits the acknowledgement request message to each of the terminals through the overhead channel when information on the overhead channel is included in a GRE header of the acknowledgement request message.

21. The method of claim 16, wherein, in the step of transmitting the acknowledgement request message, the base station transmits the acknowledgement request message to each of the terminals through the overhead channel when information on the overhead channel is included in an IP header of the acknowledgement request message.

22. The method of claim 16, wherein the overhead channel comprises one of a paging channel, an access channel, a forward common control channel, and an enhanced access channel.

23. The method of claim 16, wherein the step of generating the acknowledgement request message comprises a step of generating the acknowledgement request message by comprising information on the session and information on the overhead channel in a link control protocol (LCP) echo request message.

24. The method of claim 16, wherein the step of managing the session state comprises a step of checking the response message received from each of the terminals to perform one of an operation of maintaining the session state in the dormant state, an operation of transitioning the session state to a null state, and an operation of updating the session information.

25. A method of managing session information in a mobile communication service system having at least one terminal, a base station and a packet data serving node (PDSN), the method comprising the steps of:
generating, by each of the terminals, an acknowledgement request message comprising information on a session established with the PDSN while the session is transitioned to a dormant state, and transmitting the generated acknowledgement request message to the base station through an overhead channel;
transmitting, by the base station, the acknowledgement request message to the PDSN;
generating, by the PDSN, a response message as a result of comparing the session information included in the acknowledgement request message with previously stored session information, and transmitting the generated response message to the base station;
transmitting, by the base station, the response message to each of the terminals through the overhead channel; and
managing, by each of the terminals, a state of the session on the basis of the response message.

26. The method of claim 25, wherein the step of generating the response message comprises a step of generating the response message by encapsulating information on the overhead channel into a predetermined field of a generic route encapsulation (GRE) header.

27. The method of claim 25, wherein the step of generating the response message comprises a step of generating the response message by encapsulating information on the overhead channel into a predetermined field of an Internet protocol (IP) header.

28. The method of claim 25, wherein, in the step of transmitting the response message, the base station transmits the response message to each of the terminals through the overhead channel when information on the overhead channel is included in a GRE header of the response message.

29. The method of claim 25, wherein, in the step of transmitting the response message, the base station transmits the response message to each of the terminals through the overhead channel when information on the overhead channel is included in an IP header of the response message.

30. A least one terminal in a mobile communication service system, the terminal comprising:
wireless interface for receiving acknowledgement request message from PDSN through overhead channel, and for transmitting response message through overhead channel;
response processor for generating response message as a result of comparing the PPP session information included in the acknowledgement request message with previously stored PPP session information, and for transmitting response message to PDSN though wireless interface.

31. A method of managing session information in a mobile communication service system having at least one terminal, the method comprising the steps of:
receiving, an acknowledgement request message comprising information on a PPP session though overhead channel;
generating, a response message as a result of comparing the PPP session information included in the acknowledgement request message received with previously stored session information;
transmitting, the response message though overhead channel.
